(19) United States
(12) Patent Application Publication
(10) Pub. No.: US 2009/0078731 A1
(43) Pub. Date: Mar. 26, 2009

(54) Shopping Bag

(76) Inventor: Chong Kuk Yi, Seoul (KR)

Correspondence Address: DILWORTH & BARRESE, LLP, 333 EARLE OVINGTON BLVD., SUITE 702, UNIONDALE, NY, 11553, US

(21) Appl. No.: 12/087,838

(22) PCT Filed: Jan. 25, 2006
(86) PCT No.: PCT/KR2006/000277

§ 371 Date: Jul. 30, 2008

(30) Foreign Application Priority Data
Jan. 17, 2006 (KR) 20-2006-0001407

(51) Int. Cl. B60R 9/00

(52) U.S. Cl. 224/411; 224/572

(57) ABSTRACT

A shopping bag is formed in the shape of an “N” and able to be fixed in a shopping cart at both ends of the top part of the shopping bag having a fixing part (2) including a rib (20) for strength inside the shopping bag, and a support frame part (4) for supporting the fixing part (2) and formed as a base frame of the shopping bag, with an outer cover able to wrap the top part of the front and rear of the shopping bag, and the support frame part (4). A board is included at the bottom of the shopping bag.

### TECHNICAL FIELD

The present invention is formed as a shape of ‘∩’ to be able to fix in a shopping cart as formed in both end of the top part of a shopping bag. The shopping bag is comprising that a fixing part (2) including a rib (20) for the strength of the inside of shopping bag, and a support frame part (4) for supporting the fixing part (2) as formed basis frame of the shopping bag to be able to wrap an outer cover at the top part of front and rear of the shopping bag, and a wrapping the support frame part (4) and more including a board at the bottom of the shopping bag.

### BACKGROUND ART

The present invention relates to a shopping bag to be able to fix simply and easily with many kind of carts in a shopping bag to be able to carry goods.

### DISCLOSURE OF INVENTION

### Technical Problem

The most of a shopping bag of the conventional art was formed as an outer cover and a handle to use carrying for buying goods.

However, this kind of shopping bag of the conventional art was inconvenience to use to put buying goods for shopping because there was no a fix part to hold up the shopping bag on the shopping cart, and was troublesome for opening the shopping bag because every time a user has to open the top of the shopping bag when the user put the buying goods into the shopping bag.

Moreover, using the shopping bag of the convenience art was inconvenience and troublesome because the shopping bag had only handle in the bag or basket. The problems happened not only time-consuming but also inconvenience to use as putting the goods because the gate of the shopping bag was not wide enough, and not stand up due to without such as a fix part and a support frame part.

The shopping bag was made of materials such as plastic, paper, texture, etc., but re-usable shopping bag was encouraged to use by a cause of the environmental pollution as using a disposable bag.

### Technical Solution

An object of the present invention for overcoming the above-mentioned problems is to provide a shopping bag as usable widely the inside space, fixable with any kind of the cart, and convenient to insert in a shopping cart by a sewed outer cover.

In addition, another object of the present invention is to provide that the outer cover can fold easily including flat boards of an even number (2 to 4 pieces) at the bottom of the outer cover, and can get wider as a quantity of goods to insert a rubber band at the top of the shopping bag, and also can prevent to flow out the goods by the rubber band in case of close up the shopping bag.

Finally, the other object of the present invention is to provide a shopping bag as coverable the goods inside of the shopping bag, and to prevent the top of the shopping bag to get wider by the goods when the shopping bag is carried as connecting front and rear of the shopping bag by a string.

### ADVANTAGEOUS EFFECTS

As the above-mentioned, the present invention has an effect as follows:

Firstly, a fixing part of the present invention has an effect as fixable strongly including a fixing protrusion inside of the shopping bag, and is formed as a shape of n to be able to fix with any kind of shopping carts.

Secondly, an outer cover of the shopping bag of the present invention by sewing has an effect as usable inside space widely and is convenient to insert on the shopping cart.

Thirdly, the bottom of the shopping bag of the present invention has an effect that not to be tear off the bottom of the shopping bag even though heavy stuff inside of the shopping bag, and can fold the outer cover easily including flat boards of an even number at the bottom of the shopping bag.

Fourthly, the top of the outer cover of the present invention has an effect that can get wider as a quantity of goods to insert a rubber band at the top of the shopping bag, and also can prevent to flow out the goods by the rubber band in case of close up the shopping bag.

Fifthly, a connecting adhesive part of the present invention is coverable the goods inside of the shopping bag, and to prevent the top of the shopping bag to get wider by the goods when the shopping bag is carried as connecting front side and rear side of the shopping bag by a string, and can control the length of the width as more including at a part of the connecting adhesive part.

Sixthly, the present invention has an effect that can be reduced to a minimum a volume of the shopping bag as adhesive the front side and rear side of the shopping bag as including Velcro tape inside of the shopping bag when inside of goods are small.

Seventhly, the present invention has an effect that can control the length of the width as controlling a contact part as any point of the shopping bag in which depends on a length of Velcro tape.

Eighthly, a handle of the present invention has an effect that can control the length by a string so that it can be lifted by hand as for handle by controlling the length as shorter or put a shawl on by controlling the length as longer.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating of a shopping bag according to the present invention.

FIG. 2 is a front perspective view illustrating of a shopping bag according to the present invention.

FIG. 3 is a rear perspective view illustrating of a shopping bag according to the present invention.

FIG. 4 is a part of perspective view illustrating as when shopping bag is folded up according to the present invention.

FIG. 5 is a spread perspective view illustrating of a shopping bag according to the present invention.

FIG. 6 is a pleated perspective view illustrating of a shopping bag as closing the top according to the present invention.

FIG. 7 is a support frame part perspective view illustrating of a shopping bag according to the present invention.

FIG. 8 is both fixing part perspective view illustrating of the FIG. 7 according to the present invention.

FIG. 9 is an example showing perspective view illustrating when goods are put into a shopping bag according to the present invention.

FIG. 10 is a top perspective view illustrating of a shopping bag of the FIG. 9 according to the present invention.

FIG. 11 is an example showing perspective view illustrating when a shopping bag is set up on a shopping cart according to the present invention.

### BEST MODE FOR CARRYING OUT THE INVENTION

The present invention is formed as a shape of n to be able to fix in a shopping cart as formed in both end of the top part of a shopping bag. The shopping bag is comprising that a fixing part (2) including a rib (20) for the strength of the inside of shopping bag, and a support frame part (4) for supporting the fixing part (2) as formed basis frame of the shopping bag to be able to wrap an outer cover at the top part of front and rear of the shopping bag, and a wrapping the support frame part (4) and more including a board at the bottom of the shopping bag, and each connecting part is connecting by a sewing outer cover as wrapping a outer cover part (6) and the support frame part (4) as being formed an overall frame, and is connecting a part to front top of the shopping bag and a handle (8) as possible as the length control by a string, and a connecting adhesive part (10) as formed to be able to connect a rear part of the shopping bag by Velcro tape, and the connecting adhesive part (10) is more including a Velcro tape (11) or other fixing equip to be able to adhere to the shopping bag.

### MODE FOR THE INVENTION

For an achievement of the above-described objects, the present invention is formed as a shape of n to be able to fix in a shopping cart as formed in both end of the top part of a shopping bag. The shopping bag is comprising that a fixing part (2) including a rib (20) for the strength of the inside of shopping bag, and a support frame part (4) for supporting the fixing part (2) as formed basis frame of the shopping bag to be able to wrap an outer cover at the top part of front and rear of the shopping bag, and a wrapping the support frame part (4) and more including flat boards as even number 2 to 4 pieces at the bottom of the shopping bag, and each connecting part is connecting by a sewing outer cover as wrapping a outer cover part (6) and the support frame part (4) as being formed an overall frame, and is connecting a part to front top of the shopping bag and a handle (8) as possible as the length control by a string, and a connecting adhesive part (10) as formed to be able to connect a rear part of the shopping bag by Velcro tape (Not showing in Figure), and the connecting adhesive part (10) is more including a Velcro tape (11) to be able to adhere to the shopping bag.

The fixing part (2) comprises a rib (20) for high strength inside and a protrusion to be hanging on inside of a shopping cart. The support frame part (4) comprises a groove for reducing a fault by a crack.

The support frame part (4) comprises a Velcro tape (15) inside of the shopping bag to hide contents of inside as connecting front side and rear side of the shopping bag. The connecting adhesive part (10) is consisting of a rubber band (Not showing in Figure) at a part of the top of shopping bag to be able to connect up to a rear side of a Velcro tape (Not showing in Figure) according to a quantity of inside contents of the shopping bag.

Also, the outer cover part (6) can be changed its shape by a width of a shopping cart as inserting a rubber band (16) at the top of left and right side of the shopping bag.

As below, a particular description of the present invention will become better understand with reference to accompanying drawings in details.

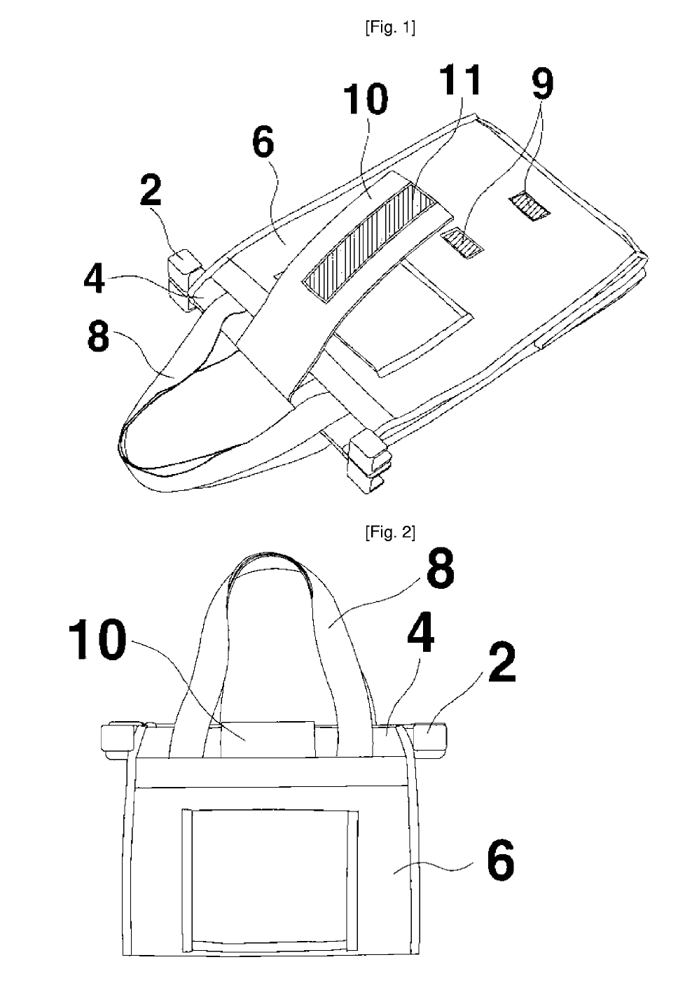

FIG. 1 is a perspective view illustrating of a shopping bag according to the present invention.

The present invention is formed as a shape of n to be able to fix in a shopping cart as formed in both end of the top part of a shopping bag. The shopping bag is comprising that a fixing part (2) including a rib (20) for the strength of the inside of shopping bag, and a support frame part (4) for supporting the fixing part (2) as formed basis frame of the shopping bag to be able to wrap an outer cover at the top part of front and rear of the shopping bag, and a wrapping the support frame part (4) and more including flat boards as even number (2 to 4) at the bottom of the shopping bag, and each connecting part is connecting by a sewing outer cover as wrapping a outer cover part (6) and the support frame part (4) as being formed an overall frame, and is connecting a part to front top of the shopping bag and a handle (8) as possible as the length control by a string, and a connecting adhesive part (10) as formed to be able to connect a rear part of the shopping bag by Velcro tape (Not showing in Figure), and the connecting adhesive part (10) is more including a Velcro tape (11) to be able to adhere to the shopping bag.

The handle (8) is consisting of a string in which can control to be able to use as a handle by controlling a string as short length, or as a shawl on by controlling the length of a string as longer.

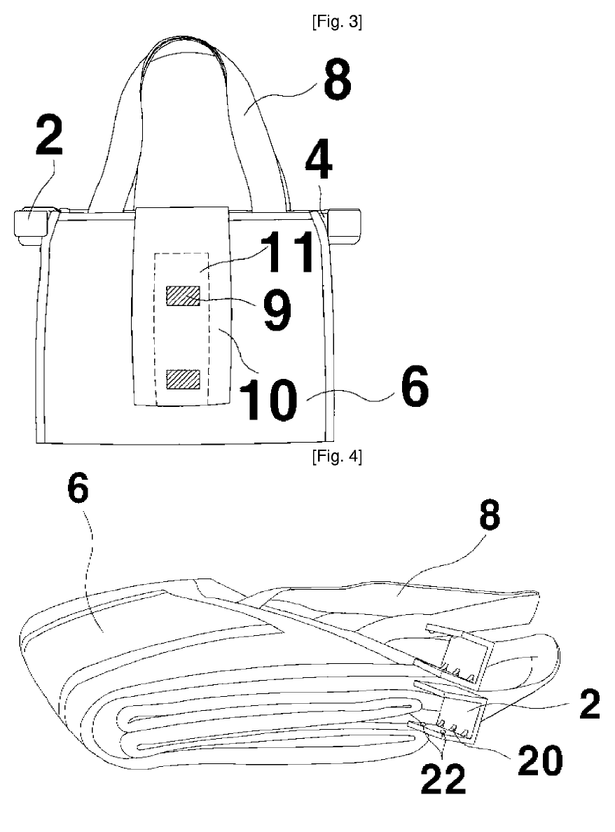

FIG. 2 is a front perspective view illustrating of a shopping bag according to the present invention. FIG. 3 is a rear perspective view illustrating of a shopping bag according to the present invention. As Figures, the present invention can store to adhere a Velcro tape (11) of inside of a connecting adhesive part (10) and 2 pieces of Velcro tape (9) at bottom of an outer cover part (6) after folding up the shopping bag.

Moreover, FIG. 4 is a part of perspective view illustrating as when shopping bag is folded up according to the present invention. The folded up part is formed as folding flat boards by 2 to 4 steps. As Figures, inside of a fixing part (2) is consisting of a rib (20) to be able to make a high intensity, and 1.5 cm to 2.5 cm of inside space to be able to fix which depends on a type of a shopping cart, and is formed a protrusion to be able to fix strongly in a part of shopping cart.

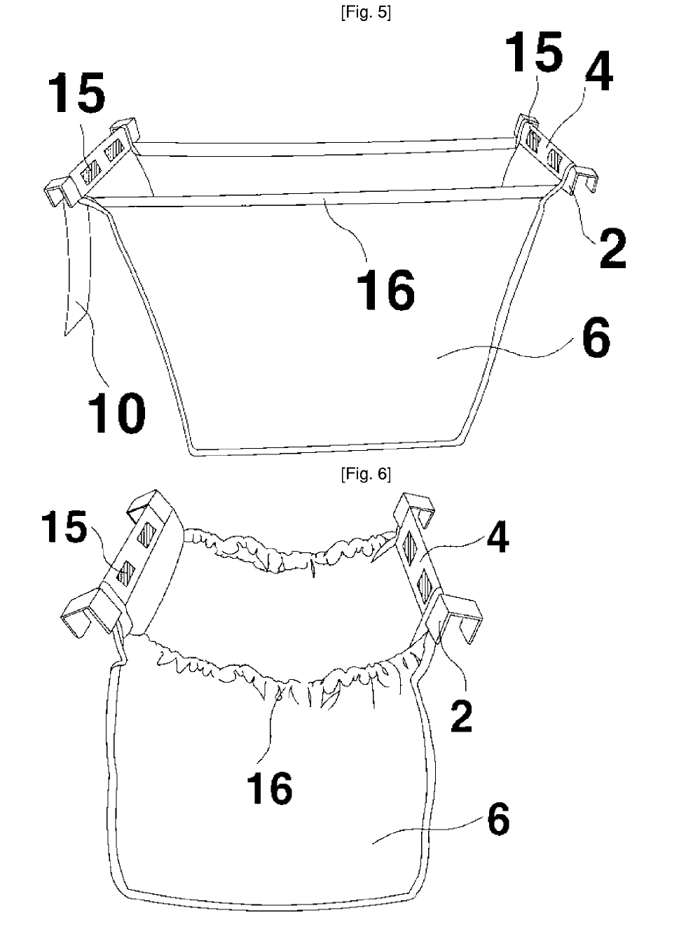

FIG. 5 is a spread perspective view illustrating of a shopping bag according to the present invention. FIG. 6 is a pleated perspective view illustrating of a shopping bag as closing the top according to the present invention. The outer cover part (6) can be changed a shape as FIG. 6 or to be maximized as FIG. 5 by a width of a shopping cart to insert a rubber band (16) at the top of a left and right side. Also, an inside of a supporting frame part (4) is more including a Velcro tape (15) so that the present invention can reduce a volume not to be shown contents externally to adhere front and rear of a shopping bag by the Velcro tape (15) in case of having a small quantity of contents.

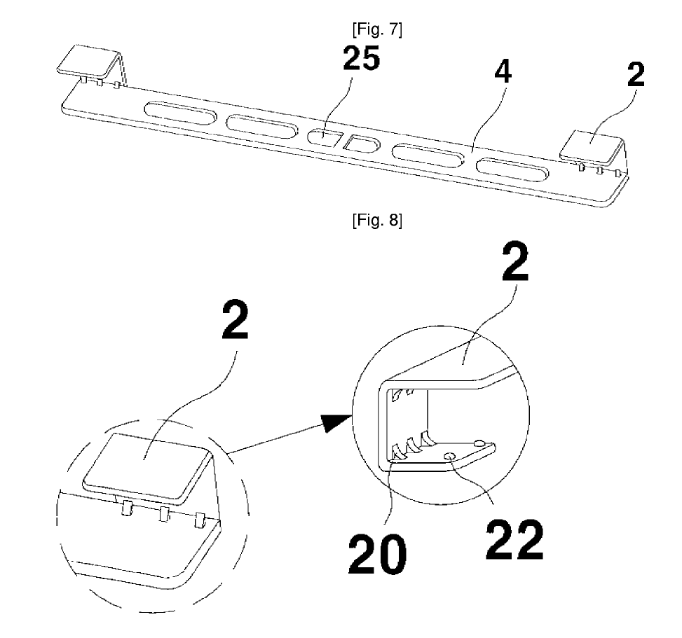

FIG. 7 is a support frame part perspective view illustrating of a shopping bag according to the present invention. FIG. 8 is both fixing part perspective view illustrating of the FIG. 7 according to the present invention.

As FIG. 7, a support frame part (4) is consisting of a groove (25) for reducing a fault by a crack, and a height of the groove (25) is a basis of a half of a supporting frame part (4). Also, in both sides of the supporting frame part (4) is consisted of a fixing part (2, detailed in FIG. 8) which makes fixable by a type of a shopping cart. An inside space of the each fixing part (2) is 15 cm to 2.5 cm, and is formed a protrusion (22) in a part of a shopping bag to be able to fix strongly in a part of shopping cart.

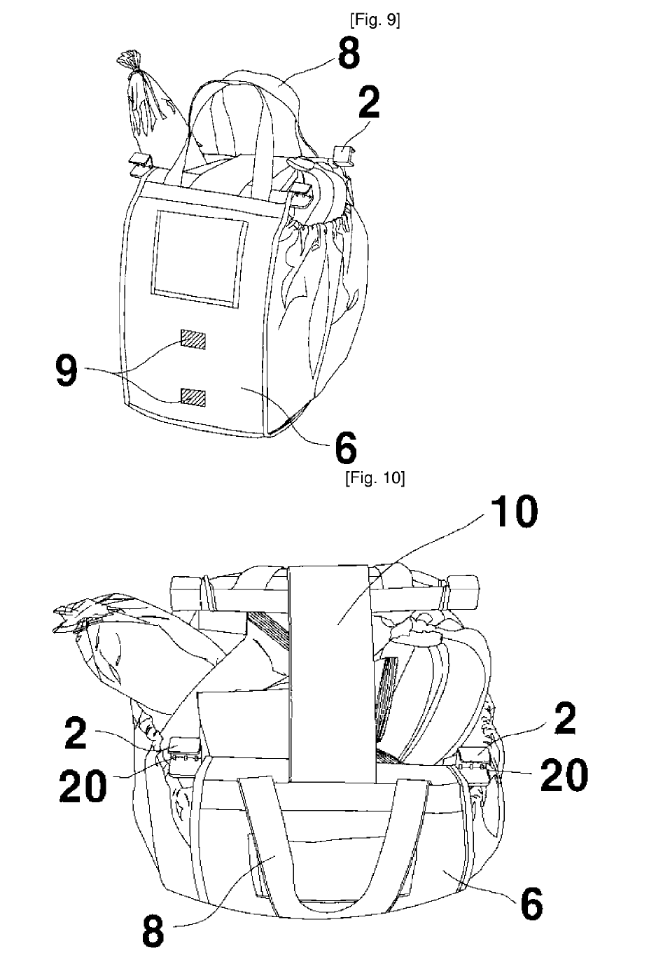

FIG. 9 is an example showing perspective view illustrating when goods are put into a shopping bag according to the present invention. FIG. 10 is a top perspective view illustrating of a shopping bag of the FIG. 9 according to the present invention. In case of many goods are inside of a shopping bag, the present invention prevents to be exposed or came out contents of shopping bag as connecting a Velcro tape (Now shown in Figure) of front and rear using by an inside of a Velcro tape (11) of a connecting adhesive part (10), also reduce a power when a shopping bag is lifted and moved. The connecting adhesive part (10) can carry into effect to be more including a rubber band (Not shown in Figure) on a part of the shopping bag.

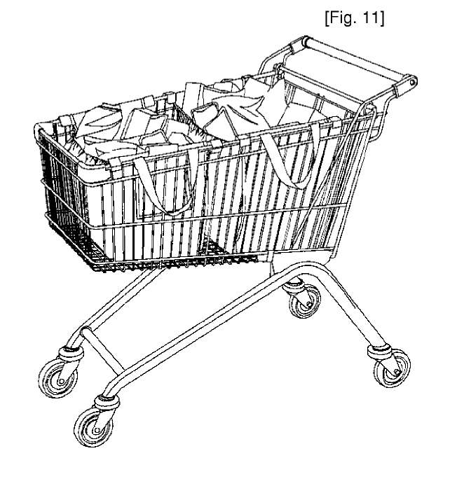

FIG. 11 is an example showing perspective view illustrating when a shopping bag is set up on a shopping cart according to the present invention. As Figure, many shopping bags are can be set up and fixed in a shopping cart. A material of the shopping cart such as steels and plastics is available to fix the shopping bag.

A Velcro tape (Not shown in Figure) of the rear shopping bag and a Velcro tape (9, 11, 15) using at an outer cover may be embodied in several forms by other snap and so on.

The present invention is not limited to the above embodiment. As the present invention may be embodied in several forms without departing from the spirit or essential characteristics thereof, it should also be understood that the above-described examples are mot limited by any of the details of the foregoing description, unless otherwise specified, but rather should be constructed broadly within its spirit and scope as defined in the appended claims, and therefore all changes and modifications that fall within the meets and bounds of the claims, or equivalences of such meets and bounds are therefore intended to be embraced by the appended claims.

1-7. (canceled)

8. In a shopping bag which can carry shopping goods, comprising: a fixing part (2) in which includes a rib (20) for high degree of strength inside of the shopping bag and is formed as a shape of n to be able to fix in a shopping cart as formed in both end of the top part of the shopping bag; a support frame part (4) in which supports the fixing part (2) and as formed basis frame of the shopping bag to be able to wrap an outer cover at a top part of front and rear of the shopping bag; a outer cover part (6) in which wraps the support frame part (4) and more including a board at a bottom of the shopping bag, in which each connecting part is connecting a whole basis frame by finishing; a handle (8) in which controls a length of a string, in which is connecting by sewing in an outer cover with wrapping the supporting frame part (4); a connecting adhesive part (10) in which connects a rear part of the shopping bag by Velcro tape, in which is connecting a part at a top of front side of the shopping bag; and said connecting adhesive part (10) in which is more including a Velcro tape (11) to be able to adhere to the shopping bag.

9. The bag of claim 8, wherein said fixing part (2) comprises a protrusion (22) to be able to hang on an inside of a shopping cart.

10. The bag of claim 8, wherein said supporting frame part (4) comprises a groove (25) for reducing a fault by a crack.

11. The bag of claim 8, wherein said supporting frame part (4) comprises a Velcro tape (15) inside of the shopping bag for invisible contents within and connecting a front and rear of the shopping bag.

12. The bag of claim 8, wherein said connecting adhesive part (10) comprises a rubber band in a part to be able to connect up to a Velcro tape of a rear as a quantity of inside contents.

13. The bag of claim 8, wherein said outer cover part (6) in which is possible to change a shape by a width of a shopping cart with inserting a rubber band (16) at a top of left and right side of the shopping bag.

14. The bag of claim 8, wherein said Velcro tape comprises a snap.

15. The bag of claim 9, wherein said Velcro tape comprises a snap.

16. The bag of claim 10, wherein said Velcro tape comprises a snap.

17. The bag of claim 11, wherein said Velcro tape comprises a snap.

18. The bag of claim 12, wherein said Velcro tape comprises a snap.

19. The bag of claim 13, wherein said Velcro tape comprises a snap.
